(19) United States
(12) Patent Application Publication
(10) Pub. No.: US 2005/0173915 A1
(43) Pub. Date: Aug. 11, 2005

(54) Steering column comprising a steering wheel for a motor vehicle

(76) Inventor: Anton Stich, Ingolstadt (DE)

Correspondence Address: Peter N Lalos;Stevens Davis Miller & Mosher, Suite 850, 1615 L Street NW, Washington, DC, 20036-5622, US

(21) Appl. No.: 10/517,519

(22) PCT Filed: Mar. 14, 2003
(86) PCT No.: PCT/EP03/02664

(30) Foreign Application Priority Data
Jun. 14, 2002 (DE) 102 26 477.5

(51) Int. Cl. B62D 1/16

(52) U.S. Cl. 280/779

(57) ABSTRACT

A system for dampening vibrations transmitted from a surface over which a vehicle traverses and the engine of the vehicle, the vehicle having a steering column being supported on a retainer connected to the body of the vehicle, operatively connected to a steering gear and having a steering wheel, generally including means for emitting suppressing vibrations, mounted on the steering column between the retainer of the steering column and the steering wheel, and operatively connected to a control means; and means for sensing vibrations, mounted on the steering column between the vibration emitting means and the steering wheel and operatively connectable to the control means.

The invention relates to a steering column comprising a steering wheel for a motor vehicle, the steering column being guided in retaining means connected to the body and being a piezoelectric actuator.

Vibrations are transmitted to the vehicle body by bumps on the roadway and engine vibrations. These vibrations are also transmitted from the body to the steering column by corresponding retaining and guide points (such as steering gear, instrument panel support) of the steering column opposite the body. These vibrations are predominantly low-frequency vibrations in the range of up to approximately 50 Hz which the driver detects through the steering wheel. In addition, body vibrations may be introduced by way of the instrument panel support.

By preference vibration dampers (DE 199 08 916 A1), such as ones in the form of a flexibly mounted additional mass are built into the steering wheel/steering column assembly to damp vibrations from bumps on the roadway and engine vibrations. The effect of such a damper is always determined for a specific frequency. Consequently, adaptation of a damper of the state of the art with respect to reduction of vibrations of the steering column/steering wheel assembly may be accomplished only with respect to the exciting frequency having the most unpleasant effect. The reduction of vibration accordingly cannot react adaptively to the various adjustment positions of the steering column/steering wheel assembly or to reaction of the driver as interface with the steering wheel.

JP 2001001911 proposes that a piezoelectric actuator the purpose of which is to compensate for the vibrations transmitted to the steering column be mounted on a ball bearing component of a steering column, in the area of penetration of the floor of the body by the steering column. The piezoelectric actuator is in contact with the ball bearing component so that the ball bearing component may rotate independently with the steering column during a steering movement. Because of the constant vibrations in vehicle operation, play which decreases the reduction of vibrations may arise between piezo actuator and ball bearing component. This solution also does not make allowance for the change in the geometry of the assembly resulting from the adaptability of the steering column/steering wheel assembly and consequently also fails to allow for the variable natural vibration behavior of the assembly.

The known solution does not prevent introduction of vibrations by way of additional retaining and steering points of the body.

The object of the invention is to effect distinct reduction of disruptive vibrations in the steering column/steering wheel assembly over a wide frequency range so that both the adaptability of the steering column/steering wheel assembly and the reaction of the driver to the steering column/steering wheel assembly may be taken into account adaptively (by self-adjustment).

It is claimed for the invention that this object is attained by the characteristics of patent claim 1. Other configurations claimed for the invention are specified in the dependent claims.

It is claimed for the invention that a piezoceramic actuator is mounted on the steering column in an area between steering wheel and adjacent retaining means (retaining means of the steering column relative to a structural component of the body). Should a joint for adjustment of the steering column be present in this area, it would be advantageous further to reduce the area for mounting the actuator to the area between the joint for adjustment of the steering column and the steering wheel. A sensor for detection of vibrations is mounted in the direction of the steering wheel from the actuator, that is, above the piezoceramic actuator. It is advantageous for this sensor to be mounted at the intersection of steering column and steering wheel or on the steering wheel itself.

The piezoceramic actuator and the sensor for detecting vibrations are connected to a control device. The sensor delivers signals which constitute a measure of the residual vibrations still present. The control device accordingly can generate a control signal which affects the longitudinal movement of the piezoceramic shells so that oscillation countering the disruptive vibrations is generated. The object is to prevent as many residual vibrations as possible from reaching the path of transmission from the steering column to the steering wheel.

The piezoceramic actuator consists of individual piezoceramic shells spaced at intervals and mounted on the circumference of a section of steering column. It is also possible, however, to form the piezoceramic actuator as a stack of piezo elements which form a longitudinal section over the cross-section of the steering column. The piezoceramic actuator is controlled by means of electric control voltage from the control device.

For the purpose of describing the invention more in detail reference will now be made, by way of an exemplary embodiment, to the accompanying drawings in which:

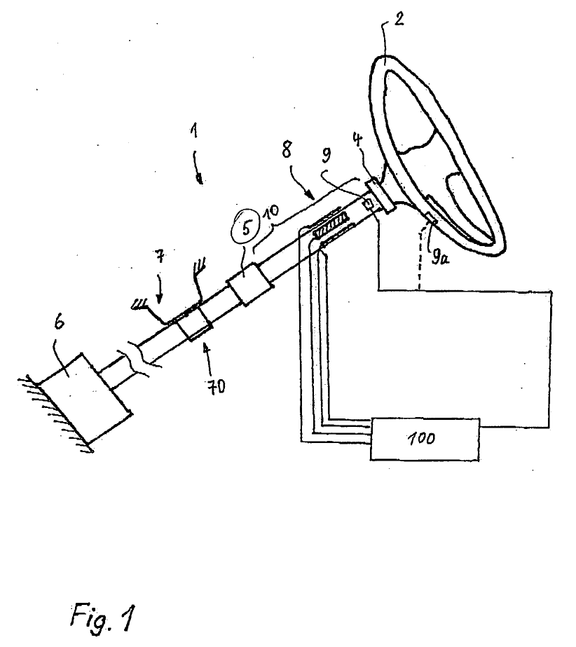

FIG. 1 illustrates the configuration of steering column with retaining means on an instrument panel support of a vehicle body and steering wheel, as well as piezoceramic actuator and sensor with control device.

As shown in FIG. 1, the steering wheel 2 is connected to the steering column 1. A joint 4 which permits movement of the steering wheel between various positions in which it may be immobilized may be introduced at the site of connection.

The steering column 1 also contains a joint 5 which makes it possible to displace the steering column horizontally and/or vertically. Below this joint 5 the steering column is connected by retaining means 70 to a structural component 7 of the body, such as a support for the instrument panel. The steering column 1 is connected to the steering gear 6 either directly or by way of other connecting elements.

In order to avoid the vibrations introduced into the steering wheel by the structural component 7 of the body with retaining means 70, a piezoceramic actuator 8 is mounted in the area between retaining means 70 and steering wheel 2, preferably above the joint 5 on the steering column, in steering column section 10. The piezoceramic actuator 8 makes it possible to introduce longitudinal and transverse oscillations into steering column section 10 in order to suppress the vibrations introduced into the steering column. This suppression of or compensation for the disruptive vibrations is effected by mounting piezoceramic actuator 8 preferably above the retaining means 70, that is, in the area between swivel joint 5 and steering wheel 2 on the steering column 1 in section 10.

The piezoceramic actuator 8 consists of a piezoceramic element which is mounted as a shell-shaped piezo layer in a steering column section in individual piezo layers around the circumference of the steering column. For example, four quarter shells 80 of a piezo layer may be mounted on the circumference of the steering column spaced at intervals from each other. These piezoceramic quarter shells are connected by way of electric connections to a control device 100 which controls the individual quarter shells of the piezoceramic actuator by a suitable control voltage. In conjunction with this control voltage the quarter shells 80 of the piezoceramic actuator 8 move more or less in the longitudinal direction relative to the longitudinal axis of the steering column and so introduce oscillations into the structure of the steering column in the longitudinal direction of the longitudinal direction of the steering column axis.

Controlled counteroscillations are thus introduced by means of the piezoceramic actuator 8 into the steering column/steering wheel assembly and excite the steering column/steering wheel assembly to perform counter-oscillations (in antiphase). Disruptive vibrations along the path of transmission to the steering wheel 2 are thereby distinctively reduced.

The configuration of a sensor 9 in the area of a joint 4 (of the intersection) of steering column 1 and steering wheel 2, which also is connected to the control device 100 makes it possible to control the control voltage for the actuator 8 on the basis of the residual vibrations detected. The sensor 9 is mounted above the piezoceramic actuator 8 (that is, in the direction of the steering wheel). It is also possible to mount a sensor 9a directly on the steering wheel 2 as the location at which the disruptive vibrations must be more or less offset. The sensor 9; 9a is a sensor for measurement of vibrations. For example, the sensor may also be a piezo ceramic or a piezo foil.

The piezoceramic actuator could also be mounted on the rim of the steering wheel.

Configuration of the piezoceramic actuator 8 is not limited to a shell-type piezo ceramic or piezo foil but may also be integrated into the structure of the steering column 1 or into the intersection (4) of steering column 1 and steering wheel 2 as a stack of piezo elements.

The use of piezoceramic actuators on the steering column affords the advantage that costly vibrating inertial masses on the steering column or in the steering wheel may be dispensed with. A simpler structure of lower weight and less space required is accordingly made possible. This lowers the cost.

1-4. (canceled)

5. A system for dampening vibrations transmitted from a surface over which a vehicle traverses, and the engine of said vehicle, said vehicle having a steering column being supported on a retainer connected to the body of said vehicle, operatively connected to a steering gear and having a steering wheel, comprising:
means for emitting suppressing vibrations, mounted on said steering column between said retainer and said steering wheel, and operatively connectable to a control means; and
means for sensing vibrations, mounted on said steering column between said vibration emitting means and said steering wheel, and operatively connectable to said control means.

6. A system according to claim 5 wherein said suppression vibration emitting means comprises a piezoceramic actuator.

7. A system according to claim 6 wherein said actuator includes at least two piezoceramic elements spaced about the periphery of said steering column and being firmly secured to the surface thereof.

8. A system according to claim 6 wherein said actuator comprises a stack of piezo elements forming a longitudinal section of said steering column across the cross-section thereof.

9. A system according to claim 5 including a control means operatively connected to said sensing means and said suppression vibration emitting means.

10. A system according to claim 9 wherein said control means is operable to apply a signal to said actuator causing said actuator to vibrate at a frequency equal and opposite in phase to a sensed frequency.
